(19) United States
(12) Patent Application Publication
(10) Pub. No.: US 2018/0200843 A1
(43) Pub. Date: Jul. 19, 2018

(54) ALUMINUM ALLOY BRAZING SHEET, METHOD FOR PRODUCING SAME AND HEAT EXCHANGER

(71) Applicant: Kabushiki Kaisha Kobe Seiko Sho (Kobe Steel, Ltd.), Hyogo (JP)

(72) Inventors: Katsuhiro MATSUKADO, Moka-shi (JP); Akihiro TSURUNO, Moka-shi (JP); Shogo YAMADA, Kariya-shi (JP); Shoei TESHIMA, Kariya-shi (JP); Tooru IKEDA, Kariya-shi (JP); Kouki NISHIYAMA, Kariya-shi (JP)

(73) Assignee: Kabushiki Kaisha Kobe Seiko Sho (Kobe Steel, Ltd.), Kobe-shi (JP)

(21) Appl. No.: 15/744,522

(22) PCT Filed: Jun. 16, 2016
(86) PCT No.: PCT/JP2016/067891

§ 371 Date: Jan. 12, 2018

(30) Foreign Application Priority Data
Jul. 29, 2015 (JP) 2015-150043

(51) Int. Cl. B23K 35/28; B32B 15/01; B23K 35/02; C22C 21/02

(52) U.S. Cl. CPC B23K 35/288; B32B 15/016; B23K 2201/14; C22C 21/02; B23K 35/0238

(57) ABSTRACT

The present invention provides an aluminum alloy brazing sheet which maintains high corrosion resistance after brazing treatment and has good brazeability, a method for producing the same, and a heat exchanger.

Disclosed are the aluminum alloy brazing sheet, the method for producing the same, and the heat exchanger, and the aluminum alloy brazing sheet having a core material and a brazing material on at least one face of the core material, in which the core material is made of an Al—Mn-based alloy or an Al—Mn—Cu-based alloy, the brazing material is made of an Al—Si—Zn-based alloy containing Si: 2 to 8% by mass and Zn: 1 to 9% by mass, a liquid phase fraction X (%) at a brazing temperature of the brazing material and a brazing material thickness Y (μm) satisfy the following formulae (1) to (3): (1) 30≤X≤80; (2) Y≥25; and (3) 1000≤X×Y≤24000, and an average length of an α phase remaining in the brazing material on the core material after brazing satisfies at least one of not less than 80% of a thickness of a residual brazing material and not less than 70 μm.

### TECHNICAL FIELD

The present invention relates to an aluminum alloy brazing sheet, a method for producing the same, and a heat exchanger.

### BACKGROUND ART

Heat exchangers mounted in automobiles and the like are produced by forming a brazing sheet made of an aluminum alloy (hereinafter sometimes referred to as “Al alloy”) into a predetermined shape, assembling and brazing. Conventionally, although a brazing sheet for tubes has a thickness of 0.3 to 0.5 mm, further thickness reduction has proceeded for the purpose of weight reduction of heat exchangers, and along with this, a brazing sheet is required to have high strength and high corrosion resistance.

Regarding a fin material for heat exchangers, further weight reduction can be achieved by using a fin that does not clad a brazing material (hereinafter referred to as “bare fin”); however, since a tube material used for this bare fin is configured to clad a brazing material on a joining surface with the bare fin, sufficient corrosion resistance cannot be obtained.

Several techniques have disclosed brazing sheets with enhanced corrosion resistance after brazing treatment of a surface cladded with a brazing material. For example, Patent Document 1 discloses a brazing sheet in which a brazing material made of an Al—Si-based alloy containing Zn is stacked on a core material made of an Al—Mn—Cu alloy to impart a sacrificial anticorrosive action to the surface after brazing as well as a method for producing the brazing sheet. In the technique disclosed in Patent Document 1, Zn is diffused from the brazing material to the core material during brazing treatment to cause the surface after brazing to have a less noble potential, and thus to impart a potential difference between the surface after brazing and a central portion of a sheet material (indicating a central portion in the thickness direction of the brazing sheet after brazing, the same applies hereinafter), thereby the sacrificial anticorrosive action will be imparted, and corrosion resistance will be enhanced.

However, in the brazing sheet disclosed in Patent Document 1, since the amount of Zn remaining on the brazed surface is small as a result of diffusion of Zn, it is difficult to impart a sufficient potential difference between the brazed surface and the central portion of the sheet material. In the brazing sheet described above, since a high concentration of Zn is contained in a flowable brazing material, preferential corrosion of a joining portion may occur.

Thus, for example, Patent Document 2 is exemplified as a technique developed to solve the problem of Patent Document 1 described above. In Patent Document 2, diffusion of Cu and Zn is controlled by controlling a thickness of a brazing material and a liquid phase fraction at a brazing temperature, thereby it is possible to achieve corrosion resistance of both a member surface and a joining portion.

### PRIOR ART DOCUMENT

### Patent Document

Patent Document 1: JP H11-343531 A

Patent Document 2: JP 2009-155673 A

### SUMMARY OF THE INVENTION

### Problems to be Solved by the Invention

However, in an aluminum alloy brazing sheet obtained according to Patent Document 2, since the member surface after brazing has a structure in which the brazing material is maintained in a solidified state, there is room for further improvement in corrosion resistance.

The present invention has been made in view of the above circumstances, and an object of the present invention is to provide an aluminum alloy brazing sheet which maintains high corrosion resistance after brazing treatment on a surface cladded with a brazing material and has good brazeability, a method for producing the same, and a heat exchanger.

### Means for Solving the Problems

The present inventors have paid attention to an internal structure of a brazing material remaining on a member surface after brazing. The interior of the brazing material after brazing has a structure in which the semi-molten brazing material is solidified. That is, the brazing material is composed of an α phase having a relatively small particle size and a eutectic phase surrounding the periphery of the α phase. The present inventors have found that the periphery of the α phase preferentially corrodes in a short period of time, and the α phase particles easily fall off in a corrosive environment. Thus, the present inventors have studied to increase the particle size of the α phase and reduce the eutectic phase surrounding the a phase, and accordingly they have found that falling off of the α phase particles is suppressed, more effective action as a sacrificial anode material is obtained, and corrosion resistance is enhanced.

The present invention has been made based on such findings. That is, the present invention has the following constitutions.

An aluminum alloy brazing sheet of the present invention is an aluminum alloy brazing sheet having a core material and a brazing material on at least one face of the core material, in which the core material is made of an Al—Mn-based alloy or an Al—Mn—Cu-based alloy, the brazing material is made of an Al—Si—Zn-based alloy containing Si: 2 to 8% by mass and Zn: 1 to 9% by mass, a liquid phase fraction X (%) at a brazing temperature of the brazing material and a brazing material thickness Y (μm) satisfy formulae (1) to (3) below: (1) 30≤X≤80; (2) Y≥25; and (3) 1000≤X×Y≤24000, and an average length of an α phase remaining in the brazing material on the core material after brazing satisfies at least one of not less than 80% of a thickness of a residual brazing material and not less than 70 μm.

This constitution imparts a potential gradient such that the potential becomes noble from a brazed surface to a central portion of a sheet material, so that high corrosion resistance can be obtained. In addition, an amount of a flowable brazing material and an amount of a residual brazing material are suitably maintained, and good brazeability can be obtained.

Further, in the aluminum alloy brazing sheet of the present invention, it is preferable that the core material is made of an Al—Mn-based alloy or an Al—Mn—Cu-based alloy and contains Mn: not more than 2.0% by mass (not including 0% by mass) and at least one of Cu: less than 2.5% by mass (not including 0% by mass) and Si: not more than 1.7% by mass (not including 0% by mass).

This constitution causes the brazed surface to have a less noble potential and generates a sufficient potential difference between the brazed surface and the central portion of the sheet material, so that high corrosion resistance can be obtained. In addition, post-brazing strength can be enhanced.

Further, in the aluminum alloy brazing sheet of the present invention, it is preferable that the core material is made of an Al—Mn-based alloy or an Al—Mn—Cu-based alloy and contains Si: not more than 0.5% by mass (not including 0% by mass).

This constitution promotes diffusion of Si from the brazing material to the core material, so that corrosion resistance can be further enhanced.

A method for producing an aluminum alloy brazing sheet of the present invention is a method for producing an aluminum alloy brazing sheet having a core material and a brazing material on at least one face of the core material, in which a liquid phase fraction X (%) at a brazing temperature of the brazing material and a brazing material thickness Y (rim) satisfy formulae (1) to (3) below: (1) 30≤X≤80; (2) Y≥25; and (3) 1000≤X×Y≤24000, and the method comprises: a core material forming step of forming a material for the core material with an Al—Mn-based alloy or an Al—Mn—Cu-based alloy; a brazing material forming step of forming a material for the brazing material with an Al—Si—Zn-based alloy containing Si: 2 to 8% by mass and Zn: 1 to 9% by mass; a rolling step of disposing the material for the brazing material on at least one face of the material for the core material and superposing the material for the core material and the material for the brazing material to pressure-bond these materials by hot-rolling and cold-rolling; and a heating step of performing heat treatment in at least one stage of a middle stage of the cold rolling and after the cold rolling, at a temperature of not lower than 410° C., and not higher than 570° C. or at a solidus temperature of the brazing material or lower for, not less than 10 minutes and not more than 20 hours.

The production method having such a constitution causes a sufficient amount of Zn to remain on a brazed surface and imparts a potential gradient such that the potential becomes noble from the brazed surface to a central portion of a sheet material, so that high corrosion resistance can be obtained. In addition, an amount of a flowable brazing material and an amount of a residual brazing material are suitably maintained, and good brazeability can be obtained.

Further, in the method for producing an aluminum alloy brazing sheet of the present invention, it is preferable that the core material is made of an Al—Mn-based alloy or an Al—Mn—Cu-based alloy and contains Mn: not more than 2.0% by mass (not including 0% by mass) and at least one of Cu: less than 2.5% by mass (not including 0% by mass) and Si: not more than 1.7% by mass (not including 0% by mass).

This constitution can further enhance corrosion resistance.

Furthermore, in the method for producing an aluminum alloy brazing sheet of the present invention, the heat treatment is performed such that Z=Σ(√(D×t)) as an integrated value of a square root of a product of a diffusion coefficient D(m²/sec) and a heating time t(sec) satisfies a relational expression of 1E−4≤Z≤1E−2. Here, the diffusion coefficient D is a function of a temperature T (° C.) of the aluminum alloy brazing sheet and can be obtained from a formula below:

D=3.5/100000×EXP[−124×1000/{8.31×(T+273.15)}].

This constitution can ideally control the diffusibility of Zn or the like in the brazing material while sufficiently promoting diffusion of Si from the brazing material to the core material.

A heat exchanger of the present invention is produced by forming the aluminum alloy brazing sheet, assembling and brazing treatment.

The heat exchanger of the present invention is produced by forming an aluminum alloy brazing sheet obtained through the method for producing an aluminum alloy brazing sheet, assembling and brazing treatment.

### Effects of the Invention

The aluminum alloy brazing sheet of the present invention maintains high corrosion resistance after brazing treatment on a surface cladded with a brazing material and has good brazeability. The method for producing an aluminum alloy brazing sheet of the present invention can produce a brazing sheet which maintains high corrosion resistance and has good brazeability. The heat exchanger of the present invention is formed of such a brazing sheet, maintains high corrosion resistance, and has good brazeability.

### BRIEF DESCRIPTION OF THE DRAWINGS

FIG. 1 is a schematic cross-sectional view showing a configuration of an aluminum alloy brazing sheet of the present embodiment.

FIG. 2 is a schematic cross-sectional view showing a configuration of the aluminum alloy brazing sheet of the present embodiment after brazing.

FIG. 3 is a schematic cross-sectional view showing a configuration of an aluminum alloy brazing sheet of a comparative example after brazing.

FIG. 4 is a schematic cross-sectional view showing a configuration of the aluminum alloy brazing sheet of the comparative example after brazing and corrosion.

FIG. 5 is a schematic cross-sectional view showing the configuration of the aluminum alloy brazing sheet of the present embodiment after brazing.

FIG. 6 is a schematic cross-sectional view showing a configuration of the aluminum alloy brazing sheet of the present embodiment after brazing and corrosion.

FIG. 7 is a diagram showing a relationship between temperature and time (cooling in the middle) in heat treatment and brazing treatment for the aluminum alloy brazing sheet of the present embodiment.

FIG. 8 is a diagram showing a relationship between the temperature and the time (continuous treatment) in the heat treatment and the brazing treatment for the aluminum alloy brazing sheet of the present embodiment.

FIG. 9 is a schematic measurement diagram used for determining falling-off suppression in corrosion resistance evaluation of examples and comparative examples.

FIG. 10 is a perspective view of a gap filling tester for evaluating brazeability.

FIG. 11 is a front view of the gap filling tester for evaluating brazeability.

### MODE FOR CARRYING OUT THE INVENTION

Hereinafter, embodiments of the present invention will be described in detail with reference to the drawings. However, the scope of the present invention is not limited to the embodiments described below as specific examples or drawings.

### (Aluminum Alloy Brazing Sheet)

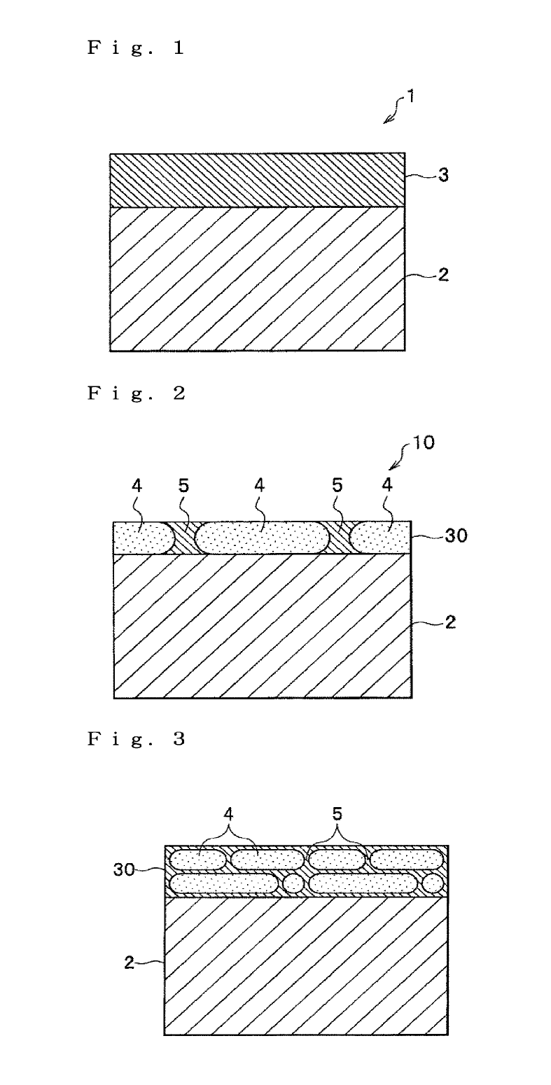

FIG. 1 is a schematic cross-sectional view showing a configuration of an aluminum alloy brazing sheet (hereinafter sometimes referred to as “brazing sheet”) 1 of the present embodiment. The brazing sheet 1 of the present embodiment has a brazing material 3 on at least one face of a core material 2. The brazing sheet 1 of the present embodiment is formed into a predetermined shape, assembled, and brazed to produce a heat exchanger. FIG. 2 is a schematic cross-sectional view showing a configuration of a brazing sheet 10 of the present embodiment after brazing. Since a portion of the brazing material 3 melts and flows due to brazing, the thickness of the brazing material is reduced to become a new brazing material 30. The interior of the brazing material 30 is composed of a plurality of α phase particles 4 and eutectic phases 5 existing in gaps between the α phase particles 4.

The present embodiment has a feature in that in the brazing material 30 remaining on a surface of the brazing sheet 10 after brazing, in order to prevent preferential corrosion around the α phase 4 and easy falling off of the α phase particles 4 under a corrosive environment, the particle size of the α phase particle 4 is increased, and the eutectic phase 5 surrounding the α phase 4 is reduced.

### [Mechanism of the Present Invention]

As a mechanism of the present invention, it is considered as follows.

When a conventional 4000-series Al—Si-based alloy (for example, alloy 4045 and the like) is used as an alloy for a brazing material, after brazing treatment, almost all of the brazing material flow from a surface of a core material and are lost.

On the other hand, in the development technique disclosed in Patent Document 2 and the like, a Si concentration and thickness of a brazing material are controlled, and a structure composed of “core material+residual brazing material” is obtained after brazing treatment, thereby the residual brazing material functions as a sacrificial anode material. When the brazing material has a low Si concentration, the brazing material is brought into a semi-molten state (solid-liquid coexisting state) composed of a liquid phase of a fluidized brazing filler and a solid phase of the α phase by heating at the time of brazing. At the time of cooling, the liquid phase remaining without flowing with the solid α phase as a nucleus is solidified, and usually becomes a granular structure composed of an α phase in a particulate form and a eutectic phase around the particles.

The residual brazing material in the above state acts as a sacrificial anode material for a core alloy in a corrosive environment. Although it is possible to make the core alloy anticorrosive, a corrosion cell is formed between the α phase particle and the eutectic phase in the residual brazing material, and corrosion proceeds near the periphery of the α phase particles as an interface between the α phase and the eutectic phase. This is corrosion that occurs regardless of anticorrosion of the core material. As a result, the sacrificial anode material wastefully wears out, and a portion of a phase particles may fall off due to corrosion around the α phase particles, deterioration of corrosion prevention performance possibly occurs.

In order to suppress and avoid such a phenomenon, it has been considered that it would be effective to reduce a liquid phase forming amount at the time of brazing, make the α phase particles to be long and large to make it difficult to cause falling off of the particles, and to lengthen the time until occurrence of the falling off. By reducing the eutectic phase, it would be effective to suppress corrosion around the α phase particles; however, there has been a risk of deterioration of brazeability.

Thus, in order to increase the length and size of the α phase particles and simultaneously achieve the reduction of the eutectic phase and the brazeability, a low-Si brazing material and a core material are combined together to be subjected to heat treatment, diffusion of Si from the brazing material to the core material is promoted, and conversion of the brazing material near the core material into a liquid phase is suppressed, thereby the structure of the residual brazing material after brazing can be improved. Here, the low-Si brazing material means a brazing material having a low Si content so that the liquid phase fraction becomes not more than 80% at a brazing temperature. As the core material to be combined with the low-Si brazing material, a core material having a low Si content is preferable.

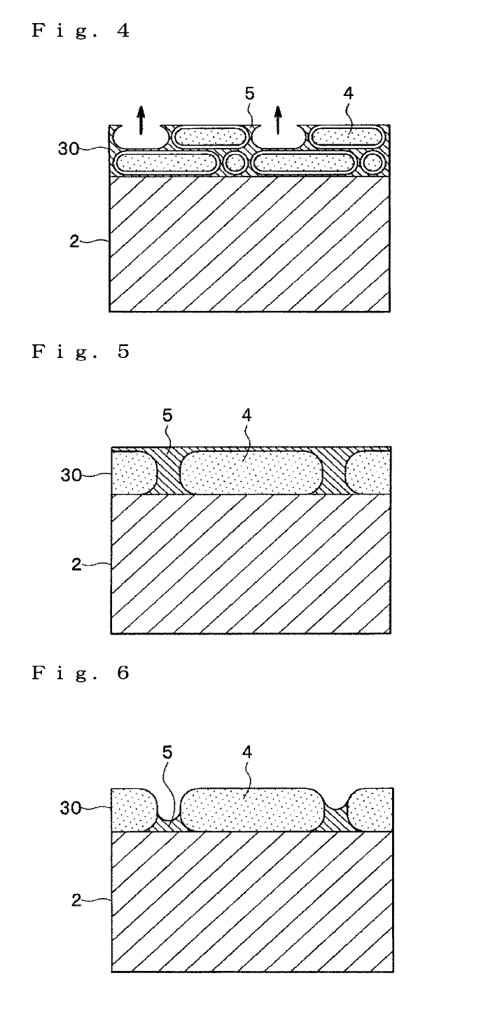

FIG. 3 is a schematic cross-sectional view showing a configuration of a brazing sheet of a comparative example after brazing in which heat treatment as a feature of the present embodiment is not performed, and FIG. 4 is a schematic cross-sectional view showing a configuration of the brazing sheet of the comparative example after brazing and a corrosion test. A brazing material 30 of the brazing sheet of the comparative example after brazing is constituted of a plurality of α phase particles 4 having a relatively small size and a eutectic phase 5 existing in gaps between the α phase particles 4. In this brazing sheet, after the corrosion test, an interface between the α phase particle 4 and the eutectic phase 5 corrodes to form a space. Thus, a portion of α phase particles 4 fall off, and large recesses are formed on the surface. Since there is a gap between the α phase particle 4 and the eutectic phase 5 parallel to the surface of a core material 2, corrosion may further proceed through this space.

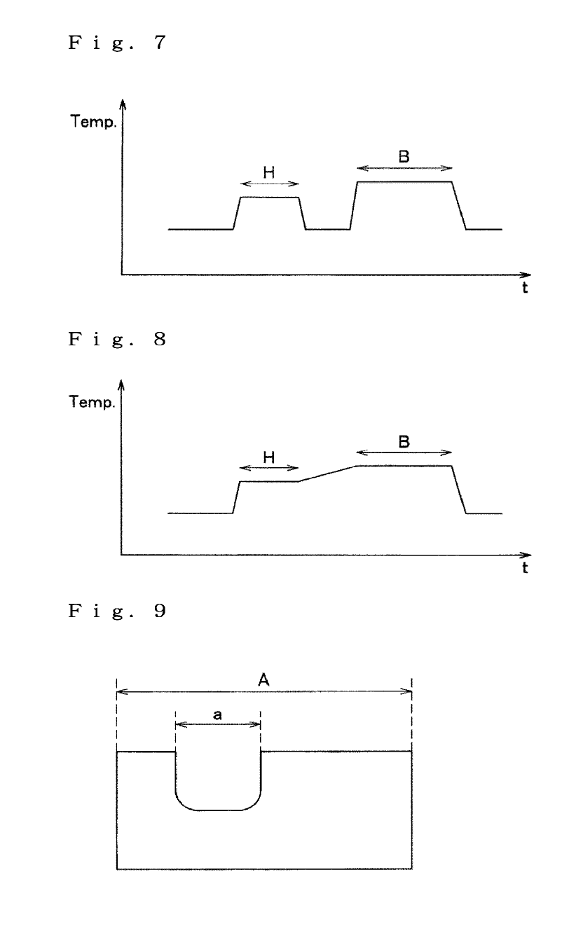

FIG. 5 is a schematic cross-sectional view showing a configuration of a brazing sheet of the present embodiment after brazing, and FIG. 6 is a schematic cross-sectional view showing a configuration of the brazing sheet of the present embodiment after brazing and a corrosion test. A brazing material 30 of the brazing sheet of the present embodiment after brazing is constituted of a plurality of α phase particles 4 having a relatively large particle size and a eutectic phase 5 existing in gaps between the α phase particles 4. Almost all of the α phase particles 4 are in contact with the vicinity of the surface of a core material 2. In this brazing sheet, after the corrosion test, a portion of the eutectic phase 5 corrodes to reduce the residual amount of the eutectic phase 5, so that small recesses may be formed in the portion of the eutectic phase 5. However, the α phase particles 4 hardly fall off, so that the recesses as shown in FIG. 4 are not formed.

In the present embodiment, the other configurations are not particularly limited as long as a brazing sheet having a core material specified by the present embodiment and a brazing material specified by the present embodiment on at least one face of the core material is used. That is, a configuration including the brazing material of the present embodiment/core material, a configuration including the brazing material of the present embodiment/core material/sacrificial material, or a configuration including the brazing material of the present embodiment/core material/sacrificial material/conventional brazing material, and the like may be adopted.

Although the thickness of the core material 2 is not particularly limited, it is preferably 50 μm to 1.2 mm, for example, in consideration of formability when being assembled as a heat exchanger, mechanical strength, weight required for the heat exchanger and the like.

Next, materials constituting the brazing sheet of the present embodiment will be described.

### [Core Material]

The core material of the brazing sheet of the present embodiment is made of an Al alloy being an Al—Mn-based alloy or an Al—Mn—Cu-based alloy. These Al alloys can be sufficiently used as a brazing sheet used for applications such as heat exchangers for automobiles in terms of physical properties such as mechanical strength.

The core material of the present embodiment contains Mn and Cu as elements other than Al. The core material may contain Si. The core material may further contain other elements. The effects and contents of these elements will be described below.

### (Mn of Core Material)

Mn has an effect of enhancing the post-brazing strength, and the post-brazing strength can be enhanced by increasing the content of Mn. Also, since Mn has a function to make the potential noble, corrosion resistance is enhanced. If the content of Mn exceeds 2.0% by mass, a coarse Al—Mn-based intermetallic compound is formed, so that formability is lowered and corrosion resistance tends to decrease. Thus, the content of Mn in the core material is preferably not more than 2.0% by mass (not including 0% by mass), more preferably 0.5 to 1.8% by mass.

### (Cu of Core Material)

Cu has an effect of making the potential noble and enhances corrosion resistance. In addition, Cu enhances the post-brazing strength. If the content of Cu is not less than 2.5% by mass, burning may occur as the melting point decreases. Here, burning is a phenomenon in which as a result of a local increase in alloy element concentration due to, for example, diffusion of Si from the brazing material, melting occurs there around (at a temperature lower than the melting point of the core matrix). Thus, the content of Cu in the core material is preferably less than 2.5% by mass (not including 0% by mass), more preferably not more than 2.0% by mass (not including 0% by mass), further preferably 0.2 to 1.0% by mass.

### (Si of Core Material)

Si has an effect of enhancing the post-brazing strength, and particularly when Si coexists with Mg or Mn, the post-brazing strength can be further enhanced by formation of a Mg—Si-based intermetallic compound or an Al—Mn—Si-based intermetallic compound. However, if the content of Si exceeds 1.7% by mass, the core material melts due to lowering of the melting point of the core material and an increase in low-melting-point phases. Thus, the content of Si in the core material is preferably not more than 1.7% by mass (not including 0% by mass).

On the other hand, since the diffusion of Si from the brazing material to the core material is facilitated and increased in amount as a difference in Si concentration between the core material and the brazing material is larger, the Si concentration of the core material is preferably lower. In the case where a core alloy contains Si not less than a Si solid solubility limit, the diffusion of Si from the brazing material to the core alloy hardly occurs.

Further, if the content of Si exceeds 0.5% by mass, it is necessary to perform heat treatment at a high temperature or for a long time in order to diffuse Si, however, diffusion of other elements also proceeds at this time, so that other material properties such as corrosion resistance are adversely affected. Thus, the content of Si in the core material is preferably not more than 0.5% by mass (not including 0% by mass), more preferably not more than 0.3% by mass (not including 0% by mass).

### (Other Elements)

Ti forms a Ti—Al-based compound in an Al alloy and is dispersed in a layer manner. Since the potential of the Ti—Al-based compound is noble, Ti has an effect of stratifying a corrosion form and making it difficult to progress corrosion (pitting corrosion) in the depth direction. If the content of Ti exceeds 0.35% by mass, coarse intermetallic compound formation reduces workability and corrosion resistance. Thus, the core material may contain Ti as long as the content of Ti is not more than 0.35% by mass.

Mg has an effect of enhancing the post-brazing strength, while Mg has an action of deteriorating the flux brazeability. Thus, if the content of Mg exceeds 0.5% by mass, Mg diffuses to the brazing material during brazing, and the brazeability is remarkably deteriorated. Thus, the core material may contain Mg as long as the content of Mg is not more than 0.5% by mass (preferably not more than 0.3% by mass).

Examples of alloys to be added in addition to the above elements are those described below. For the purpose of adjusting corrosion resistance (potential), the core material may contain Sn and In as long as the total content of Sn and In is not more than 0.1% by mass. In addition, in order to make the potential of the core material noble and enhance the strength, the core material may contain Cr, Ni or Zr, and Fe as long as each content is not more than 0.3% by mass.

### (Balance, Inevitable Impurities)

In the core material, except for each composition component described above, the balance is composed of Al and inevitable impurities. The inevitable impurities may be contained within the range not hindering the effect of the present invention. The inevitable impurities are acceptable if the total amount of the inevitable impurities is less than approximately 1.0% by mass.

### [Brazing Material]

The brazing material of the brazing sheet of the present embodiment is made of an Al alloy of an Al—Si—Zn-based alloy containing Si: 2 to 8% by mass and Zn: 1 to 9% by mass.

The brazing material of the present embodiment contains Si and Zn as elements other than Al. The brazing material may further contain other elements. The effect and content of these elements will be described below.

### (Si of Brazing Material)

Si has an action of lowering the melting point of the Al alloy and increasing the liquid phase fraction at a brazing temperature and fluidity. If the Si content is less than 2% by mass, the amount of a brazing filler is insufficient during brazing, and the brazeability deteriorates. On the other hand, if the Si content exceeds 8% by mass, a flowing amount of the brazing filler becomes excessive, and in addition to bonding failure due to a reduction in sheet thickness, brazing failure such as erosion due to excess amount occurs. Thus, the content of Si in the brazing material is set to 2 to 8% by mass. The content of Si in the brazing material is preferably 3.5 to 7% by mass.

### (Zn of Brazing Material)

Zn has an action of making the potential of the Al alloy less noble and has an action of lowering the melting point and increasing the liquid phase fraction. If the Zn content is less than 1% by mass, since the amount of Zn remaining on the surface after brazing is extremely small, enhancement of corrosion resistance is hardly observed. On the other hand, if the content of Zn exceeds 9% by mass, the concentration of Zn contained in a flowable brazing material increases, which causes preferential corrosion in a fillet or the like. Thus, the content of Zn in the brazing material is set to 1 to 9% by mass. The content of Zn in the brazing material is preferably 2 to 7% by mass.

Since both of Si and Zn have the action of lowering the melting point of the Al alloy and increasing a liquid phase fraction X, it is preferable that the amount of each of Si and Zn to be added is determined by thermodynamic calculation such that the following formula (1) is satisfied, and in addition, a thickness Y is determined such that the above-described formulae (2) and (3) are satisfied.

### (Other Elements)

In addition to the above-described alloy components, In, Sn or the like making the potential of the Al alloy less noble may be appropriately added to the brazing material.

### (Balance, Inevitable Impurities)

In the brazing material, except for each composition component described above, the balance is composed of Al and inevitable impurities. The inevitable impurities may be contained within the range not hindering the effect of the present invention. The inevitable impurities are acceptable if the total amount of the inevitable impurities is less than approximately 1.0% by mass.

Since the alloy elements contained in the core material diffuse into the brazing material during the production process and the brazing treatment, the brazing material after brazing contains these alloy elements as inevitable impurities.

### (Liquid Phase Fraction X at Brazing Temperature, Brazing Material Thickness Y)

In the present embodiment, a liquid phase fraction X (%) at the brazing temperature of the brazing material and a brazing material thickness Y (μm) satisfy the following formulae (1) to (3):

30≤X≤80; (1)

Y≥25; and (2)

1000≤X×Y≤24000. (3)

When the brazing material is thin, since Si in the brazing material is remarkably lowered due to diffusion of Si in the production process (annealing) and the brazing treatment, the brazeability significantly deteriorates. In addition, since the amount of the brazing material is small, it is difficult to sufficiently perform brazing when the brazing material thickness Y is less than 25 μm. Thus, the brazing material thickness Y is set to not less than 25 μm. The brazing material thickness Y is preferably not less than 40 μm. The upper limit value of the brazing material thickness Y is not particularly limited because it depends on sheet thickness, bonding point density and the like, however, it is preferably ½ of the sheet thickness.

By reducing the liquid phase fraction X at the brazing temperature of the brazing material, the amount of the melting and flowing brazing material can be reduced. Thus, it is possible to adjust the amount of the brazing material, which increases along with the brazing material thickness, to an amount suitable for brazing with a fin and the like. If the liquid phase fraction X of the brazing material is less than 30%, the fluidity of the brazing material decreases, so that sufficient brazeability cannot be secured. If the liquid phase fraction X of the brazing material exceeds 80%, a flowing amount of the brazing material becomes excessive, and in addition to bonding failure between members due to a reduction in sheet thickness, brazing failure such as erosion due to excess amount occurs. Thus, the liquid phase fraction X at the brazing temperature of the brazing material is set to 30 to 80%. The liquid phase fraction X is preferably 45 to 75%. “%” as a unit of the liquid phase fraction X generally represents “mol %”.

The liquid phase fraction X (%) at the brazing temperature of the brazing material is a value calculated from material components of the brazing material used for cladding by standard thermodynamic calculation software (for example, Thermo-Calc).

When a heat exchanger is assembled using the brazing sheet, in the case of containing the above-described amount of Zn in the brazing material, the above-described formulae (1) to (3) are satisfied, so that a sufficient amount of Zn remains on the brazed surface. This makes it possible to make the potential noble from the brazed surface to the central portion of the sheet material. Thus, when the brazing sheet is used such that the brazing material is disposed in a corrosive environment, a sacrificial anticorrosive effect is remarkably exhibited.

When the above-described formulae (1) to (3) are satisfied, an absolute amount of the flowable brazing material formed during brazing treatment can be optimized, so that good brazeability can be obtained.

Consequently, for example, in brazing with a fin and the like, production of an appropriate absolute amount of the flowable brazing material is secured, and sufficient brazeability can be obtained. Furthermore, an appropriate absolute amount of the residual brazing material is secured, and the sacrificial anticorrosive effect due to the residual brazing material is sufficiently exhibited.

If a product of the liquid phase fraction X and the brazing material thickness Y is less than 1000, the absolute amount of the flowable brazing material decreases, so that sufficient brazeability cannot be secured. For example, formation of a fillet becomes insufficient, and the bonding strength decreases. On the other hand, if the product of the liquid phase fraction X and the brazing material thickness Y exceeds 24000, the absolute amount of the flowable brazing material increases, so that a change in thickness of the brazing sheet before and after brazing treatment increases to cause bonding failure between members. In addition, erosion of the core material caused by the flowable brazing material excessively formed occurs, and the corrosion resistance decreases. Thus, the product (X×Y) of the liquid phase fraction X and the brazing material thickness Y is set to 1000 to 24000. The product (X×Y) of the liquid phase fraction X and the brazing material thickness Y is preferably 1500 to 15000.

### (Average Length of α Phase Remaining on Core Material)

In the present embodiment, an average length of the α phase remaining on the core material after brazing satisfies at least one of not less than 80% of a thickness of a residual brazing material and not less than 70 μm.

Since corrosion of the residual brazing material layer proceeds at the interface between the residual α phase and the eutectic phase, it is possible to reduce progression of the corrosion by increasing the size of the residual a phase and to suppress falling off of the α phase particles.

When the residual brazing material thickness is as small as less than 70 μm, in the case where the average length of the α phase particles is equal to or greater than 80% of the residual brazing material thickness, the interface between the residual α phase and the eutectic phase is sufficiently reduced, and a corrosion suppressing effect can be obtained.

When the average length of the α phase is not less than 70 μm, since the α phase particles are sufficiently large, a corrosion path required to cause falling off increases, so that falling off is sufficiently suppressed.

Thus, the average length of the α phase remaining on the core material after brazing satisfies at least one of not less than 80%© of the residual brazing material thickness and not less than 70 μm. More preferably, at least one of not less than 90% of the residual brazing material thickness and not less than 80 μm is satisfied.

When the α phase particle is regarded as a square in the cross sectional image of the brazing sheet, the average length of the α phase is defined as an average length of a side of the square and calculated by the following formula (4):

average length(μm)of α phase=√(residual brazing material area/number of α phase particles) (4)

Here, the residual brazing material area is obtained as a sum of five visual fields. The number of the α phase particles is obtained as a sum obtained by counting the particles in five visual fields.

From a cross-sectional shape of the residual brazing material, the a phase is roughly rectangular, and it is actually practical to define the size as a rectangular parallelepiped or square. When the size is defined as a side of the square, most of α phases are arranged as single layers in the case where the average size is equal to or larger than the residual brazing material thickness, and the falling off due to corrosion is greatly reduced.

### [Method for Producing Brazing Sheet]

Specific examples of the method for producing a brazing sheet of the present embodiment will be described.

Although explanation will be made herein in accordance with the embodiment of the brazing material+the core material, the same explanation applies to the case where a sacrificial material is cladded on the other side of the core material, the case where a brazing material is further cladded on the side provided with the sacrificial material, the case where a lining material is provided, or the case where the kind of the brazing material is changed.

The method for producing a brazing sheet of the present embodiment is a method for producing an aluminum alloy brazing sheet having a core material and a brazing material on at least one face of the core material, in which the liquid phase fraction X (%) at the brazing temperature of the brazing material and the brazing material thickness Y (μm) satisfy the following formulae (1) to (3):

30≤X≤80; (1)

Y≥25; and (2)

1000≤X×Y≤24000. (3)

The production method includes a core material forming step of forming a material for the core material with an Al—Mn-based alloy or an Al—Mn—Cu-based alloy; a brazing material forming step of forming a material for the brazing material with an Al—Si—Zn-based alloy containing Si: 2 to 8% by mass and Zn: 1 to 9% by mass; a rolling step of disposing the material for the brazing material on at least one face of the material for the core material and superposing the material for the core material and the material for the brazing material to pressure-bond these materials by hot-rolling and cold-rolling; and a heating step of performing heat treatment in at least one stage of a middle stage of the cold rolling and after the cold rolling, at a temperature of not lower than 410° C., and not higher than 570° C. or at a solidus temperature of the brazing material or lower, for not less than 10 minutes and not more than 20 hours.

First, in view of the corrosion resistance required for the brazing sheet, the concentration of Zn contained in the brazing material, the residual brazing material thickness, and the amount of the flowable brazing material are determined, and based on these determinations, the brazing material thickness Y and the liquid phase fraction X at the brazing temperature are determined so as to satisfy the above formulae (1) to (3). Further, each composition of an aluminum alloy for the core material and an aluminum alloy for the brazing material is determined.

After such design is made, in an actual production process, first, the aluminum alloy for the core material and the aluminum alloy for the brazing material are each melted and cast by continuous casting. If necessary, each aluminum alloy is face-milled and subjected to homogenizing heat treatment, thus obtaining an ingot for the core material (a material for the core material) and an ingot for the brazing material. The ingot for the brazing material is hot rolled or cut to have a predetermined thickness, and a material for the brazing material is produced.

The material for the brazing material is disposed on one face of the ingot for the core material (a brazing material, a lining material, a sacrificial anode material or the like may be disposed on the other face of the ingot for the core material as required), superposed so as to have a predetermined clad rate, heated at a temperature of not lower than 400° C., and then pressure-bonded by hot rolling to be formed into a sheet material. Thereafter, the sheet material is subjected to cold rolling—intermediate annealing—cold rolling, so that the sheet material has a predetermined sheet thickness. The final cold working ratio is preferably 30 to 60%. After obtaining a final sheet thickness, finish annealing may be performed in consideration of forming processability. By the finish annealing, the material softens and the elongation improves, so that the workability can be enhanced.

It is desirable that the heating step described later is carried out in at least one stage of the middle stage of the cold rolling and after the cold rolling in the above process.

### (Heating Step)

In the present embodiment, the heat treatment in the heating step is performed prior to the brazing treatment or performed as a preliminary stage for the brazing treatment. Further, the heat treatment is carried out in order to increase the particle size of the α phase in the brazing material, reduce the eutectic phase surrounding the α phase, and control the Si concentration distribution in the brazing material. The higher the heat treatment temperature is and the longer the heat treatment time is, the larger the diffusion amount is. However, since other additive elements (for example, Cu in the core material and Zn in the brazing material) also diffuse at the same time due to the heat treatment, excessive heat treatment adversely affects the corrosion resistance (specifically, a potential difference necessary for the sacrificial anticorrosive action cannot be maintained).

Thus, as heating conditions, it is necessary that the temperature is not lower than 410° C., and not higher than 570° C. or the solidus temperature of the brazing material or lower, and the time is not less than 10 minutes and not more than 20 hours. Preferably, the temperature is 420° C. to 480° C., and the time is 1 to 6 hours.

The heat treatment in the present embodiment serves as intermediate annealing and/or finish annealing which are usually performed, and heating and annealing can be carried out at the same time. The heat treatment may be performed a plurality of times. Specific examples of the processes include:
(i) hot rolling→cold rolling→heat treatment (intermediate annealing)=finish rolling→finish annealing;
(ii) hot rolling→cold rolling→intermediate annealing→finish rolling→heat treatment (finish annealing); and
hot rolling→cold rolling→heat treatment (intermediate annealing)→finish rolling→heat treatment (finish annealing).

Here, as described above, the heat treatment in the present embodiment is performed at not lower than 410° C. Thus, the intermediate annealing in (ii) above is performed at lower than 410° C., and the heat treatment (intermediate annealing) in (i) and (iii) above is performed at not lower than 410° C. Similarly, the finish annealing in (i) above is performed at lower than 410° C., and the heat treatment (finish annealing) in (ii) and (iii) above is performed at not lower than 410° C.

It is preferable to perform the heat treatment such that Z=Σ(√/(D×t)) as an integrated value of the square root of the product of a diffusion coefficient D(m²/sec) and a heating time t(sec) satisfies a relational expression of 1E−4≤Z≤1E−2. √/(D×t) is a representative value of a diffusion distance of Si in the Al alloy of the brazing material, and is an index indicating the degree of diffusion. The diffusion coefficient D is a function of a temperature T (° C.) of the aluminum alloy brazing sheet and can be obtained from the following formula (5):

D=(3.5/100000)×EXP[−124×1000/{8.31×(T+273.15)}] (5)

Z=Σ(√(D×t)) is calculated by calculating D at a temperature every 1 second by the above formula (5) in the temperature range of not lower than 350° C. and integrating the square root (√D) thereof.

The above formula (5) relating to the diffusion coefficient D is derived by fitting characteristic values of materials related to diffusion of Si in an Al—Si alloy obtained by Bergner into the following general formula (6) relating to the diffusion coefficient (see Kenichi Hirano, Light Metals, vol. 29, No. 6, pp. 249 to 262 (1979)).

D=D₀×EXP[−Q/{R×(T+273.15)}] (6)

where D₀ is a diffusion constant (vibration factor), Q is an activation energy of diffusion, R is a gas constant, and T is degrees Celsius.

The temperature range to be applied is 618 to 904° K (344 to 631° C.) and encompasses the temperature range of the heat treatment of the present embodiment.

If Z=Σ(√(D×t)) exceeds 1E−2 that falls within the above range, diffusion becomes excessive, and Si in the brazing material decreases. Thus, the amount of the flowing brazing material decreases, and the brazeability tends to deteriorate. In addition, since diffusion of Zn, Cu and the like proceeds excessively, the potential difference decreases, and the corrosion resistance tends to decrease. However, since the average length of the a phase increases, falling off of the α phase particles is reduced.

On the other hand, if Z=Σ(√D×t)) is less than 1E−4 that falls within the above range, diffusion becomes insufficient, a layer which lacks of Si becomes thin in the brazing material, and the amount of the flowing brazing material increases. Since the average length of the α phase decreases, falling off of the α phase particles increases, and the corrosion resistance tends to be reduced. However, since the diffusion of Zn, Cu and the like proceeds, the potential difference increases.

Thus, when Z=Σ(√(D×t)) satisfies the above-described relational expression of 1E−4≤Z≤1E−2, a layer in which Si is not diffused is appropriately formed in the brazing material; the brazing material flows appropriately; falling off of the α phase particles is suppressed; Zn, Cu and the like are appropriately diffused; and the corrosion resistance becomes good.

The relationship between the heat treatment and the brazing treatment will be described with reference to FIGS. 7 and 8. FIGS. 7 and 8 are diagrams each showing a relationship between the temperature and the time in the heat treatment and the brazing treatment for the brazing sheet. H represents a heat treatment time. B represents a brazing treatment time.

FIG. 7 shows the relationship between the temperature and the time when after the heat treatment the blazing sheet is once cooled and subjected to the brazing treatment. FIG. 8 shows the relationship between the temperature and the time when the blazing sheet is subjected to the brazing treatment continuously without being cooled after the heat treatment. The heat treatment may be performed under any conditions. Here, the brazing temperature during the brazing treatment means the melting point of the brazing material, that is, a temperature that is equal to or higher than the melting point of the eutectic phase. Further, the brazing treatment means that a temperature is maintained at the solidus temperature of the brazing material or higher.

The brazing sheet obtained in the present embodiment is then formed into a predetermined shape, assembled, and brazed to produce a heat exchanger.

### EXAMPLES

The above has described embodiments for carrying out the present invention. The following will specifically describe examples in which the effects of the invention have been verified while compared with comparative examples that do not satisfy the constitutional requirements of the invention. However, the present invention is not limited to the following examples.

### (Preparation of Sample Material)

For a core material having the composition shown in Table 1 and a brazing material having the composition shown in Table 2, a material for a core material and a material for a brazing material were prepared according to the production method including the core material forming step and the brazing material forming step described above. As to steps, methods and conditions not described, known ones were used.

Next, various core materials and brazing materials shown in Tables 3 to 7 were combined and then superposed. Each of the resulting materials was hot rolled and cladded at 450° C., and then cold rolled without rough annealing so as to have a predetermined sheet thickness (0.4 mmt, 0.6 mmt, 0.8 mmt, 2.0 mmt).

Thereafter, for sample materials Nos. 1 to 47, a 0.6 mmt cladding material was subjected to heat treatment as intermediate annealing under the conditions described in Tables 3 and 4. In addition, cold rolling was performed at a predetermined working ratio to prepare a sample material having a thickness of 400 μm.

For sample materials Nos. 48 to 77, a cladding material having a thickness of 400 μm was prepared by cold rolling at a predetermined working ratio. Thereafter, heat treatment as finish annealing was performed under the conditions described in Tables 4 and 5 to prepare a sample material having a thickness of 400 μm.

For sample materials Nos. 78 to 81, a 0.6 mmt or 0.8 mmt cladding material was subjected to heat treatment as intermediate annealing under the conditions described in Table 5. Thereafter, cold rolling was performed at a predetermined working ratio as required to obtain a 0.6 mint cladding material. In addition, a second heat treatment as intermediate annealing was performed under the conditions described in Table 5. In addition, cold rolling was performed at a predetermined working ratio to prepare a sample material having a thickness of 400 μm.

For sample materials Nos. 82 and 83, a 0.6 mmt or 0.8 mmt cladding material was subjected to heat treatment as intermediate annealing under the conditions described in Table 5. Thereafter, cold rolling was performed at a predetermined working ratio to obtain a 0.4 mmt cladding material. In addition, a second heat treatment as finish annealing was performed under the conditions described in Table 5 to prepare a sample material having a thickness of 400 μm.

For sample materials Nos. 84 to 117, a 0.6 mmt or 2.0 mmt cladding material was subjected to heat treatment as intermediate annealing under the conditions described in Table 6. In addition, cold rolling was performed at a predetermined working ratio to prepare a sample material having a thickness of 400 μm.

For sample materials Nos. 118 to 127, a 0.4 mmt or 0.6 mmt cladding material was subjected to heat treatment as finish annealing under the conditions described in Table 6 to prepare a sample material having a thickness of 400 μm or 600 μm.

For sample materials Nos. 128 to 137, a 0.6 mmt cladding material was subjected to heat treatment as intermediate annealing under the conditions described in Table 7. In addition, cold rolling was performed at a predetermined working ratio to prepare a sample material having a thickness of 400 μm.

For sample materials Nos. 138 to 147, a 0.4 mmt cladding material was subjected to heat treatment as finish annealing under the conditions described in Table 7 to prepare a sample material having a thickness of 400 μm.

The following characteristics were evaluated for the prepared sample materials.

### (Liquid Phase Fraction X)

The liquid phase fraction X (%) at the brazing temperature of the brazing material is calculated using Thermo-Calc. Here, Thermo-Calc refers to thermodynamic calculation software developed at the Royal Institute of Technology in Sweden.

### (Brazing Material Thickness Y)

The brazing material thickness Y (μm) is obtained as an average value of five points by observing a cross section of the aluminum alloy brazing sheet before brazing treatment.

### (Diffusion Coefficient D)

The diffusion coefficient D is a diffusion coefficient of Si in an Al—Si alloy, which is obtained by Bergner. This is the function of the temperature T (° C.) of the aluminum alloy brazing sheet and is obtained from the following formula (5):

D=(3.5/100000)×EXP[−124×1000/{8.31×(T+273.15)}] (5)

### (Average Length of α Phase)

A commercially available non-corrosive flux was applied onto a surface of the brazing material of each prepared sample material at 3 g/m², the resulting sample material was suspended with a jig to be held at 590 to 600° C. for 2 minutes in a nitrogen atmosphere having a dew point of −40° C. and an oxygen concentration of not more than 200 ppm, thereby brazing heating was performed to prepare a brazing treatment material. Cross-section observation of this sample material was performed using an optical microscope. Keller etching was performed as required to obtain cross sectional images (magnification: 50 times) of arbitrary five points.

When the α phase particle was regarded as a square in each cross sectional image, the average length (μm) of the α phase was defined as an average length of a side of the square and calculated by the following formula (4), and an average value of five points was obtained.

average length(μm)of α phase=√(residual brazing material area/number of α phase particles) (4)

Here, the residual brazing material area was obtained as a sum of five visual fields. The number of the α phase particles was obtained as a sum obtained by counting the particles in five visual fields.

### (Brazeability)

FIG. 10 is a perspective view of a gap filling tester for evaluating the brazeability. FIG. 11 is a front view of the gap filling tester.

A test piece having a size of 25 mm in width×60 mm in length was cut out from the sample material, and a commercially available non-corrosive flux was applied onto the surface of the blazing material side of the test piece at 5 g/m² and dried. As shown in FIG. 10, the test piece (lower sheet 12) was placed such that the surface of the blazing material side applied with the flux faced upward, and a 3003 alloy sheet (upper sheet 11) having a size of 1 mm in thickness×25 mm in width×55 mm in length was stood vertically to the test piece and fixed with a wire 14 with a stainless steel round bar having a size of φ2 mm as a spacer 13 interposed between the lower sheet 12 and the upper sheet 11. At this time, the position of the spacer 13 was set at a distance of 50 mm from one end of the test piece. These materials were subjected to heat treatment (holding at 590 to 600° C. for 2 minutes in a nitrogen atmosphere having a dew point of −40° C. and an oxygen concentration of not more than 200 ppm) under conditions simulating brazing. As shown in FIG. 11, a gap filling length L of a fillet 15 filled in a gap between the test piece (lower sheet 12) and the 3003 alloy sheet (upper sheet 11) was measured. When the gap filling length L was not less than 30 mm, it was judged that the brazeability was good.

### (Corrosion Resistance)

A test material of 60 mm×50 mm was cut out from a brazing heat treatment material obtained by the same method as the evaluation of the α phase size described above, a surface opposite to the surface of the blazing material side and an end surface were sealed with a seal tape such that the surface of the blazing material side served as a test surface, and the resulting material was subjected to a CASS test (JIS Z 2371:2000) for 1000 hours. After the test, the maximum corrosion depth was measured to calculate a core material corrosion depth (=maximum corrosion depth-residual brazing material thickness after brazing) (μm). The acceptance criterion for this corrosion resistance test is that the core material corrosion depth is not more than 100 μm.

The corrosion depth is indicated based on a core material surface. That is, when corrosion passes through a residual brazing material and the interior of the core material corrodes, its corrosion depth is indicated as ◯◯ μm as a positive value. On the other hand, when the corrosion remains in the residual brazing material and has not reached the core material surface, the corrosion depth is indicated as −◯◯μm as a negative value.

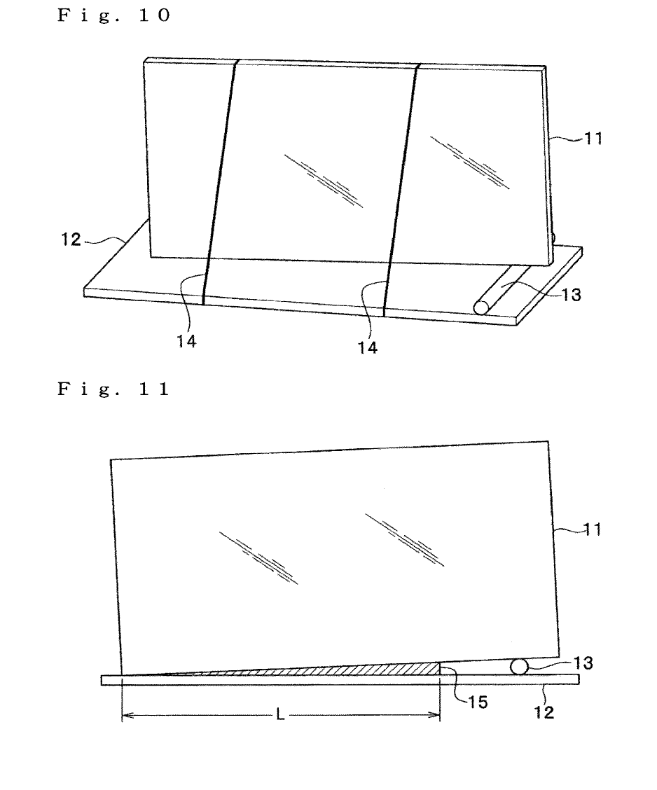

Regarding suppression of particle falling-off, in the same manner as above, a test material subjected to the CASS test for 500 hours was used. A length of the falling-off portion due to corrosion in the eutectic phase was observed in 10 visual fields of an optical microscope observation image at a magnification of 100 times in an arbitrary cross section of the test material after the CASS test. FIG. 9 is a schematic measurement diagram used for determining falling-off suppression. A is the length of the test material, and a indicates a length of a portion of the test material in which falling off occurs (particle falling-off generation portion). In FIG. 9, the ratio of the particle falling-off generation portion is obtained as a numerical value (%) of (100×a/A). The acceptance criterion for this corrosion resistance test is that the ratio of the particle falling-off generation portion is not more than 50%.

Evaluation results are shown in Tables 3 to 7. In the table 6, “-” indicates that the measurement could not be made.

TABLE 1

| | Composition of core material (mass %) | | |
|---|---|---|---|
| Number of | Balance: Al + inevitable impurities | | |
| core material | Mn | Cu | Si |
| C1 | 1.6 | 0.8 | — |
| C2 | 1.6 | 0.8 | 0.1 |
| C3 | 1.6 | 0.8 | 0.2 |
| C4 | 1.6 | 0.8 | 0.5 |
| C5 | 1.6 | 0.8 | 0.7 |
| C6 | 1.6 | 0.8 | 1.3 |
| C7 | 1.6 | 2.0 | 0.0 |

TABLE 2

| | Composition of brazing material | | Liquid | Brazing | |
|---|---|---|---|---|---|
| Number | (mass %) | | phase | material | |
| of | Balance: Al + | | fraction | thickness | |
| brazing | inevitable impurities | | X | Y | |
| material | Si | Zn | (%) | (μm) | X × Y |
| F1 | 6 | 3 | 69.3 | 100 | 6930 |
| F2 | 4 | 5 | 59.4 | 100 | 5940 |
| F3 | 7 | 2 | 78.7 | 100 | 7870 |
| F4 | 2 | 1 | 12.5 | 100 | 1250 |
| F5 | 2 | 9 | 30.1 | 100 | 3010 |
| F6 | 8 | 1 | 87.7 | 100 | 8770 |
| F7 | 8 | 9 | 100.0 | 100 | 10000 |
| F8 | 6 | 3 | 69.3 | 200 | 13860 |
| F9 | 6 | 3 | 69.3 | 25 | 1733 |
| F10 | 6 | 3 | 69.3 | 10 | 693 |
| F11 | 4 | 5 | 59.4 | 10 | 594 |
| F12 | 7 | 2 | 78.7 | 10 | 787 |
| F13 | 2 | 1 | 12.5 | 200 | 2500 |
| F14 | 2 | 9 | 30.1 | 10 | 301 |
| F15 | 8 | 1 | 87.7 | 10 | 877 |
| F16 | 8 | 9 | 100.0 | 10 | 1000 |
| F17 | 2 | 9 | 30.1 | 25 | 753 |
| F18 | 4 | 5 | 59.4 | 500 | 29700 |

TABLE 3

| Number | Number | | | | |
|---|---|---|---|---|---|
| of | of | Number | Heating step | Heating step | Z = |
| sample | brazing | of core | Heating timing | Heating | Σ (√(D · t)) |
| material | material | material | (Thickness (mm)) | condition | (m) |
| 1 | F1 | C1 | Intermediate annealing (0.6 t) | 450° C. × 3 h | 2.16E−03 |
| 2 | F1 | C2 | Intermediate annealing (0.6 t) | 450° C. × 3 h | 2.16E−03 |
| 3 | F1 | C3 | Intermediate annealing (0.6 t) | 450° C. × 3 h | 2.16E−03 |
| 4 | F1 | C4 | Intermediate annealing (0.6 t) | 450° C. × 3 h | 2.16E−03 |
| 5 | F1 | C5 | Intermediate annealing (0.6 t) | 450° C. × 3 h | 2.16E−03 |
| 7 | F1 | C7 | Intermediate annealing (0.6 t) | 450° C. × 3 h | 2.16E−03 |
| 8 | F2 | C1 | Intermediate annealing (0.6 t) | 450° C. × 3 h | 2.16E−03 |
| 9 | F2 | C5 | Intermediate annealing (0.6 t) | 450° C. × 3 h | 2.16E−03 |
| 10 | F3 | C1 | Intermediate annealing (0.6 t) | 450° C. × 3 h | 2.16E−03 |
| 11 | F3 | C5 | Intermediate annealing (0.6 t) | 450° C. × 3 h | 2.16E−03 |
| 12 | F5 | C1 | Intermediate annealing (0.6 t) | 450° C. × 3 h | 2.16E−03 |
| 13 | F5 | C5 | Intermediate annealing (0.6 t) | 450° C. × 3 h | 2.16E−03 |
| 14 | F8 | C1 | Intermediate annealing (0.6 t) | 450° C. × 3 h | 2.16E−03 |
| 15 | F8 | C5 | Intermediate annealing (0.6 t) | 450° C. × 3 h | 2.16E−03 |
| 16 | F9 | C1 | Intermediate annealing (0.6 t) | 450° C. × 3 h | 2.16E−03 |
| 17 | F9 | C5 | Intermediate annealing (0.6 t) | 450° C. × 3 h | 2.16E−03 |
| 18 | F1 | C1 | Intermediate annealing (0.6 t) | 420° C. × 10 m | 9.01E−05 |
| 19 | F1 | C1 | Intermediate annealing (0.6 t) | 420° C. × 1 h | 4.68E−04 |
| 20 | F1 | C1 | Intermediate annealing (0.6 t) | 420° C. × 3 h | 1.37E−03 |
| 21 | F1 | C1 | Intermediate annealing (0.6 t) | 420° C. × 7 h | 3.19E−03 |
| 22 | F1 | C1 | Intermediate annealing (0.6 t) | 420° C. × 20 h | 9.07E−03 |
| 23 | F1 | C1 | Intermediate annealing (0.6 t) | 450° C. × 10 m | 1.48E−04 |
| 24 | F1 | C1 | Intermediate annealing (0.6 t) | 450° C. × 1 h | 7.39E−04 |
| 25 | F1 | C1 | Intermediate annealing (0.6 t) | 450° C. × 3 h | 2.16E−03 |
| 26 | F1 | C1 | Intermediate annealing (0.6 t) | 450° C. × 7 h | 4.99E−03 |
| 27 | F1 | C1 | Intermediate annealing (0.6 t) | 450° C. × 20 h | 1.42E−02 |
| 28 | F1 | C1 | Intermediate annealing (0.6 t) | 500° C. × 10 m | 3.01E−04 |
| 29 | F1 | C1 | Intermediate annealing (0.6 t) | 500° C. × 1 h | 1.45E−03 |
| 30 | F1 | C1 | Intermediate annealing (0.6 t) | 500° C. × 3 h | 4.19E−03 |
| 31 | F1 | C1 | Intermediate annealing (0.6 t) | 500° C. × 7 h | 9.69E−03 |

| | Average | | Average length | | Corrosion | Corrosion |
|---|---|---|---|---|---|---|
| | length of α | | of α phase in | | resistance | resistance |
| | phase in | Residual | residual | | Core | Particle |
| Number | residual | brazing | brazing | Brazing | material | falling-off |
| of | brazing | material | material/ | Gap filling | corrosion | generation |
| sample | material | thickness | thickness | length | depth | portion |
| material | (μm) | (μm) | (%) | (mm) | (μm) | (%) |
| 1 | 92 | 92 | 100 | 43 | −3 | 29 |
| 2 | 90 | 93 | 97 | 44 | 2 | 29 |
| 3 | 91 | 91 | 100 | 44 | −2 | 31 |
| 4 | 87 | 90 | 97 | 43 | −3 | 32 |
| 5 | 86 | 90 | 96 | 44 | 3 | 32 |
| 7 | 91 | 93 | 98 | 44 | 5 | 34 |
| 8 | 95 | 95 | 100 | 38 | −12 | 26 |
| 9 | 89 | 93 | 96 | 41 | −18 | 30 |
| 10 | 90 | 89 | 101 | 43 | 11 | 30 |
| 11 | 87 | 86 | 101 | 44 | 8 | 35 |
| 12 | 94 | 87 | 108 | 37 | −3 | 27 |
| 13 | 90 | 85 | 106 | 36 | −5 | 29 |
| 14 | 102 | 165 | 62 | 44 | −20 | 25 |
| 15 | 98 | 162 | 60 | 45 | −12 | 23 |
| 16 | 28 | 24 | 117 | 32 | 41 | 21 |
| 17 | 25 | 21 | 119 | 33 | 37 | 27 |
| 18 | 77 | 94 | 82 | 40 | −1 | 34 |
| 19 | 78 | 92 | 85 | 42 | −1 | 32 |
| 20 | 83 | 93 | 89 | 41 | 2 | 31 |
| 21 | 84 | 93 | 90 | 43 | 1 | 29 |
| 22 | 87 | 97 | 90 | 44 | 0 | 28 |
| 23 | 83 | 95 | 87 | 44 | −1 | 36 |
| 24 | 85 | 93 | 91 | 40 | −1 | 34 |
| 25 | 92 | 94 | 98 | 43 | −3 | 29 |
| 26 | 93 | 96 | 97 | 40 | −2 | 28 |
| 27 | 97 | 96 | 101 | 39 | 1 | 26 |
| 28 | 82 | 92 | 89 | 38 | 3 | 34 |
| 29 | 90 | 94 | 96 | 37 | 2 | 29 |
| 30 | 94 | 94 | 100 | 37 | −1 | 28 |
| 31 | 97 | 91 | 107 | 36 | −2 | 29 |

TABLE 4

| | Number | | | | |
|---|---|---|---|---|---|
| Number | of | Number | Heating step | Heating step | Z = |
| of sample | brazing | of core | Heating timing | Heating | Σ (√(D · t)) |
| material | material | material | (Thickness (mm)) | condition | (m) |
| 32 | F1 | C1 | Intermediate annealing (0.6 t) | 500° C. × 20 h | 2.75E−02 |
| 33 | F1 | C5 | Intermediate annealing (0.6 t) | 420° C. × 10 m | 9.01E−05 |
| 34 | F1 | C5 | Intermediate annealing (0.6 t) | 420° C. × 1 h | 4.68E−04 |
| 35 | F1 | C5 | Intermediate annealing (0.6 t) | 420° C. × 3 h | 1.37E−03 |
| 36 | F1 | C5 | Intermediate annealing (0.6 t) | 420° C. × 7 h | 3.19E−03 |
| 37 | F1 | C5 | Intermediate annealing (0.6 t) | 420° C. × 20 h | 9.07E−03 |
| 38 | F1 | C5 | Intermediate annealing (0.6 t) | 450° C. × 10 m | 1.48E−04 |
| 39 | F1 | C5 | Intermediate annealing (0.6 t) | 450° C. × 1 h | 7.39E−04 |
| 40 | F1 | C5 | Intermediate annealing (0.6 t) | 450° C. × 3 h | 2.16E−03 |
| 41 | F1 | C5 | Intermediate annealing (0.6 t) | 450° C. × 7 h | 4.99E−03 |
| 42 | F1 | C5 | Intermediate annealing (0.6 t) | 450° C. × 20 h | 1.42E−02 |
| 43 | F1 | C5 | Intermediate annealing (0.6 t) | 500° C. × 10 m | 3.01E−04 |
| 44 | F1 | C5 | Intermediate annealing (0.6 t) | 500° C. × 1 h | 1.45E−03 |
| 45 | F1 | C5 | Intermediate annealing (0.6 t) | 500° C. × 3 h | 4.19E−03 |
| 48 | F1 | C5 | Intermediate annealing (0.6 t) | 500° C. × 7 h | 9.69E−03 |
| 47 | F1 | C5 | Intermediate annealing (0.6 t) | 500° C. × 20 h | 2.75E−02 |
| 48 | F1 | C1 | Finish annealing (0.4 t) | 420° C. × 10 m | 9.01E−05 |
| 49 | F1 | C1 | Finish annealing (0.4 t) | 420° C. × 1 h | 4.68E−04 |
| 50 | F1 | C1 | Finish annealing (0.4 t) | 420° C. × 3 h | 1.37E−03 |
| 51 | F1 | C1 | Finish annealing (0.4 t) | 420° C. × 7 h | 3.19E−03 |
| 52 | F1 | C1 | Finish annealing (0.4 t) | 420° C. × 20 h | 9.07E−03 |
| 53 | F1 | C1 | Finish annealing (0.4 t) | 450° C. × 10 m | 1.48E−04 |
| 54 | F1 | C1 | Finish annealing (0.4 t) | 450° C. × 1 h | 7.39E−04 |
| 55 | F1 | C1 | Finish annealing (0.4 t) | 450° C. × 3 h | 2.16E−03 |
| 56 | F1 | C1 | Finish annealing (0.4 t) | 450° C. × 7 h | 4.99E−03 |
| 57 | F1 | C1 | Finish annealing (0.4 t) | 450° C. × 20 h | 1.42E−02 |
| 58 | F1 | C1 | Finish annealing (0.4 t) | 500° C. × 10 m | 3.01E−04 |
| 59 | F1 | C1 | Finish annealing (0.4 t) | 500° C. × 1 h | 1.45E−03 |
| 60 | F1 | C1 | Finish annealing (0.4 t) | 500° C. × 3 h | 4.19E−03 |
| 61 | F1 | C1 | Finish annealing (0.4 t) | 500° C. × 7 h | 9.69E−03 |
| 62 | F1 | C1 | Finish annealing (0.4 t) | 500° C. × 20 h | 2.75E−02 |

| | Average | | Average length | | Corrosion | Corrosion |
|---|---|---|---|---|---|---|
| | length of α | | of α phase in | | resistance | resistance |
| | phase in | Residual | residual | | Core | Particle |
| | residual | brazing | brazing | Brazing | material | falling-off |
| Number | brazing | material | material/ | Gap filling | corrosion | generation |
| of sample | material | thickness | thickness | length | depth | portion |
| material | (μm) | (μm) | (%) | (mm) | (μm) | (%) |
| 32 | 100 | 94 | 106 | 36 | 3 | 27 |
| 33 | 77 | 94 | 82 | 43 | 0 | 34 |
| 34 | 77 | 95 | 81 | 44 | −3 | 36 |
| 35 | 84 | 94 | 89 | 44 | 1 | 35 |
| 36 | 82 | 93 | 88 | 43 | 1 | 33 |
| 37 | 90 | 93 | 97 | 44 | −1 | 31 |
| 38 | 83 | 91 | 91 | 44 | 0 | 34 |
| 39 | 84 | 96 | 88 | 42 | 3 | 33 |
| 40 | 89 | 94 | 95 | 43 | −3 | 29 |
| 41 | 91 | 95 | 96 | 41 | −1 | 29 |
| 42 | 93 | 93 | 100 | 41 | 0 | 28 |
| 43 | 83 | 90 | 92 | 39 | 4 | 32 |
| 44 | 89 | 91 | 98 | 39 | −2 | 32 |
| 45 | 90 | 96 | 94 | 38 | 1 | 27 |
| 48 | 94 | 94 | 100 | 38 | −1 | 30 |
| 47 | 97 | 94 | 103 | 37 | 5 | 29 |
| 48 | 82 | 91 | 90 | 41 | −1 | 32 |
| 49 | 83 | 95 | 87 | 42 | 0 | 34 |
| 50 | 87 | 92 | 95 | 40 | 0 | 35 |
| 51 | 86 | 94 | 91 | 39 | 5 | 28 |
| 52 | 90 | 91 | 99 | 37 | 7 | 27 |
| 53 | 84 | 90 | 93 | 40 | 1 | 33 |
| 54 | 89 | 93 | 96 | 39 | −2 | 31 |
| 55 | 93 | 94 | 99 | 38 | −2 | 27 |
| 56 | 94 | 92 | 102 | 38 | 1 | 26 |
| 57 | 95 | 92 | 103 | 37 | 3 | 24 |
| 58 | 86 | 95 | 91 | 35 | 7 | 33 |
| 59 | 90 | 95 | 95 | 34 | 5 | 32 |
| 60 | 97 | 91 | 107 | 34 | 3 | 27 |
| 61 | 98 | 91 | 108 | 36 | 5 | 27 |
| 62 | 100 | 92 | 109 | 33 | 1 | 25 |

TABLE 5

| Number | Number | | | | |
|---|---|---|---|---|---|
| of | of | Number | Heating step | Heating step | Z = |
| sample | brazing | of core | Heating timing | Heating | Σ (√(D · t)) |
| material | material | material | (Thickness (mm)) | condition | (m) |
| 63 | F1 | C5 | Finish annealing (0.4 t) | 420° C. × 10 m | 9.01E−05 |
| 64 | F1 | C5 | Finish annealing (0.4 t) | 420° C. × 1 h | 4.68E−04 |
| 65 | F1 | C5 | Finish annealing (0.4 t) | 420° C. × 3 h | 1.37E−03 |
| 66 | F1 | C5 | Finish annealing (0.4 t) | 420° C. × 7 h | 3.19E−03 |
| 67 | F1 | C5 | Finish annealing (0.4 t) | 420° C. × 20 h | 9.07E−03 |
| 68 | F1 | C5 | Finish annealing (0.4 t) | 450° C. × 10 m | 1.48E−04 |
| 69 | F1 | C5 | Finish annealing (0.4 t) | 450° C. × 1 h | 7.39E−04 |
| 70 | F1 | C5 | Finish annealing (0.4 t) | 450° C. × 3 h | 2.16E−03 |
| 71 | F1 | C5 | Finish annealing (0.4 t) | 450° C. × 7 h | 4.99E−03 |
| 72 | F1 | C5 | Finish annealing (0.4 t) | 450° C. × 20 h | 1.42E−02 |
| 73 | F1 | C5 | Finish annealing (0.4 t) | 500° C. × 10 m | 3.01E−04 |
| 74 | F1 | C5 | Finish annealing (0.4 t) | 500° C. × 1 h | 1.45E−03 |
| 75 | F1 | C5 | Finish annealing (0.4 t) | 500° C. × 3 h | 4.19E−03 |
| 76 | F1 | C5 | Finish annealing (0.4 t) | 500° C. × 7 h | 9.69E−03 |
| 77 | F1 | C5 | Finish annealing (0.4 t) | 500° C. × 20 h | 2.75E−02 |
| 78 | F1 | C1 | Intermediate annealing (0.6 t) | 450° C. × 3 h | 2.90E−03 |
| | | | → Intermediate annealing (0.6 t) | → 450° C. × 1 h | |
| 79 | F1 | C1 | Intermediate annealing (0.8 t) | 450° C. × 3 h | 2.90E−03 |
| | | | → Intermediate annealing (0.6 t) | → 450° C. × 1 h | |
| 80 | F1 | C1 | Intermediate annealing (0.6 t) | 420° C. × 1 h | 2.63E−03 |
| | | | → Intermediate annealing (0.6 t) | → 450° C. × 3 h | |
| 81 | F1 | C1 | Intermediate annealing (0.8 t) | 420° C. × 1 h | 2.63E−03 |
| | | | → Intermediate annealing (0.6 t) | → 450° C. × 3 h | |
| 82 | F1 | C1 | Intermediate annealing (0.6 t) | 450° C. × 1 h | 1.21E−03 |
| | | | → Finish annealing (0.4 t) | → 420° C. × 1 h | |
| 83 | F1 | C1 | Intermediate annealing (0.8 t) | 450° C. × 1 h | 1.21E−03 |
| | | | → Finish annealing (0.4 t) | → 420° C. × 1 h | |

| | Average | | Average length | | Corrosion | Corrosion |
|---|---|---|---|---|---|---|
| | length of α | | of α phase in | | resistance | resistance |
| | phase in | Residual | residual | | Core | Particle |
| Number | residual | brazing | brazing | Brazing | material | falling-off |
| of | brazing | material | material/ | Gap filling | corrosion | generation |
| sample | material | thickness | thickness | length | depth | portion |
| material | (μm) | (μm) | (%) | (mm) | (μm) | (%) |
| 63 | 81 | 95 | 85 | 35 | 2 | 32 |
| 64 | 83 | 92 | 90 | 34 | −1 | 33 |
| 65 | 86 | 93 | 92 | 34 | 3 | 36 |
| 66 | 89 | 94 | 95 | 38 | 2 | 34 |
| 67 | 91 | 90 | 101 | 35 | 4 | 33 |
| 68 | 84 | 89 | 94 | 41 | −5 | 31 |
| 69 | 87 | 91 | 96 | 39 | 0 | 32 |
| 70 | 92 | 95 | 97 | 39 | −3 | 31 |
| 71 | 91 | 93 | 98 | 38 | 0 | 27 |
| 72 | 36 | 92 | 39 | 38 | −2 | 26 |
| 73 | 84 | 91 | 92 | 36 | 3 | 30 |
| 74 | 87 | 94 | 93 | 35 | 1 | 31 |
| 75 | 91 | 93 | 98 | 36 | 5 | 28 |
| 76 | 94 | 89 | 106 | 35 | 2 | 28 |
| 77 | 98 | 95 | 103 | 35 | 6 | 29 |
| 78 | 95 | 91 | 104 | 42 | −1 | 28 |
| 79 | 98 | 96 | 102 | 43 | 3 | 27 |
| 80 | 99 | 95 | 104 | 42 | 4 | 28 |
| 81 | 94 | 94 | 100 | 44 | 2 | 29 |
| 82 | 91 | 93 | 98 | 42 | 3 | 30 |
| 83 | 92 | 92 | 100 | 40 | 1 | 29 |

TABLE 6

| Number | Number | | | | |
|---|---|---|---|---|---|
| of | of | Number | Heating step | Heating step | Z = |
| sample | brazing | of core | Heating timing | Heating | Σ (√(D · t)) |
| material | material | material | (Thickness (mm)) | condition | (m) |
| 84 | F4 | C1 | Intermediate annealing (0.6 t) | 450° C. × 3 h | 2.16E−03 |
| 85 | F4 | C5 | Intermediate annealing (0.6 t) | 450° C. × 3 h | 2.16E−03 |
| 86 | F6 | C1 | Intermediate annealing (0.6 t) | 450° C. × 3 h | 2.16E−03 |
| 87 | F6 | C5 | Intermediate annealing (0.6 t) | 450° C. × 3 h | 2.16E−03 |
| 88 | F7 | C1 | Intermediate annealing (0.6 t) | 450° C. × 3 h | 2.16E−03 |
| 89 | F7 | C5 | Intermediate annealing (0.6 t) | 450° C. × 3 h | 2.16E−03 |
| 90 | F10 | C1 | Intermediate annealing (0.6 t) | 450° C. × 3 h | 2.16E−03 |
| 91 | F10 | C5 | Intermediate annealing (0.6 t) | 450° C. × 3 h | 2.16E−03 |
| 92 | F11 | C1 | Intermediate annealing (0.6 t) | 450° C. × 3 h | 2.16E−03 |
| 93 | F11 | C5 | Intermediate annealing (0.6 t) | 450° C. × 3 h | 2.16E−03 |
| 94 | F12 | C1 | Intermediate annealing (0.6 t) | 450° C. × 3 h | 2.16E−03 |
| 95 | F12 | C5 | Intermediate annealing (0.6 t) | 450° C. × 3 h | 2.16E−03 |
| 96 | F13 | C1 | Intermediate annealing (0.6 t) | 450° C. × 3 h | 2.16E−03 |
| 97 | F13 | C5 | Intermediate annealing (0.6 t) | 450° C. × 3 h | 2.16E−03 |
| 98 | F14 | C1 | Intermediate annealing (0.6 t) | 450° C. × 3 h | 2.16E−03 |
| 99 | F14 | C5 | Intermediate annealing (0.6 t) | 450° C. × 3 h | 2.16E−03 |
| 100 | F15 | C1 | Intermediate annealing (0.6 t) | 450° C. × 3 h | 2.16E−03 |
| 101 | F15 | C5 | Intermediate annealing (0.6 t) | 450° C. × 3 h | 2.16E−03 |
| 102 | F16 | C1 | Intermediate annealing (0.6 t) | 450° C. × 3 h | 2.16E−03 |
| 103 | F16 | C5 | Intermediate annealing (0.6 t) | 450° C. × 3 h | 2.16E−03 |
| 104 | F17 | C1 | Intermediate annealing (2.0 t) | 450° C. × 3 h | 2.16E−03 |
| 105 | F17 | C5 | Intermediate annealing (2.0 t) | 450° C. × 3 h | 2.16E−03 |
| 106 | F18 | C1 | Intermediate annealing (2.0 t) | 450° C. × 3 h | 2.16E−03 |
| 107 | F18 | C5 | Intermediate annealing (2.0 t) | 450° C. × 3 h | 2.16E−03 |
| 108 | F1 | C1 | Intermediate annealing (0.6 t) | 350° C. × 10 m | 3.17E−05 |
| 109 | F1 | C1 | Intermediate annealing (0.6 t) | 350° C. × 1 h | 1.44E−04 |
| 110 | F1 | C1 | Intermediate annealing (0.6 t) | 350° C. × 3 h | 4.13E−04 |
| 111 | F1 | C1 | Intermediate annealing (0.6 t) | 350° C. × 7 h | 9.50E−04 |
| 112 | F1 | C1 | Intermediate annealing (0.6 t) | 350° C. × 20 h | 2.70E−03 |
| 113 | F1 | C5 | Intermediate annealing (0.6 t) | 350° C. × 10 m | 3.17E−05 |
| 114 | F1 | C5 | Intermediate annealing (0.6 t) | 350° C. × 1 h | 1.44E−04 |
| 115 | F1 | C5 | Intermediate annealing (0.6 t) | 350° C. × 3 h | 4.13E−04 |
| 116 | F1 | C5 | Intermediate annealing (0.6 t) | 350° C. × 7 h | 9.50E−04 |
| 117 | F1 | C5 | Intermediate annealing (0.6 t) | 350° C. × 20 h | 2.70E−03 |
| 118 | F1 | C1 | Finish annealing (0.4 t) | 350° C. × 10 m | 3.17E−05 |
| 119 | F1 | C1 | Finish annealing (0.4 t) | 350° C. × 1 h | 1.44E−04 |
| 120 | F1 | C1 | Finish annealing (0.4 t) | 350° C. × 3 h | 4.13E−04 |
| 121 | F1 | C1 | Finish annealing (0.4 t) | 350° C. × 7 h | 9.50E−04 |
| 122 | F1 | C1 | Finish annealing (0.4 t) | 350° C. × 20 h | 2.70E−03 |
| 123 | F1 | C5 | Finish annealing (0.6 t) | 350° C. × 10 m | 3.17E−05 |
| 124 | F1 | C5 | Finish annealing (0.6 t) | 350° C. × 1 h | 1.44E−04 |
| 125 | F1 | C5 | Finish annealing (0.6 t) | 350° C. × 3 h | 4.13E−04 |
| 126 | F1 | C5 | Finish annealing (0.6 t) | 350° C. × 7 h | 9.50E−04 |
| 127 | F1 | C5 | Finish annealing (0.6 t) | 350° C. × 20 h | 2.70E−03 |

| | Average | | Average length | | Corrosion | Corrosion |
|---|---|---|---|---|---|---|
| | length of α | | of α phase in | | resistance | resistance |
| | phase in | Residual | residual | | Core | Particle |
| Number | residual | brazing | brazing | Brazing | material | falling-off |
| of | brazing | material | material/ | Gap filling | corrosion | generation |
| sample | material | thickness | thickness | length | depth | portion |
| material | (μm) | (μm) | (%) | (mm) | (μm) | (%) |
| 84 | 74 | 92 | 80 | 22 | 1 | 32 |
| 85 | 73 | 93 | 78 | 23 | −2 | 33 |
| 86 | 17 | 25 | 68 | 47 | 117 | 35 |
| 87 | 13 | 23 | 57 | 43 | 118 | 38 |
| 88 | — | — | — | 47 | 102 | — |
| 89 | — | — | — | 44 | 105 | — |
| 90 | 9 | 10 | 90 | 21 | 70 | 25 |
| 91 | 8 | 9 | 89 | 17 | 51 | 21 |
| 92 | 10 | 9 | 111 | 22 | 65 | 23 |
| 93 | 9 | 8 | 113 | 24 | 43 | 25 |
| 94 | 8 | 10 | 80 | 27 | 117 | 19 |
| 95 | 7 | 10 | 70 | 25 | 125 | 35 |
| 96 | 105 | 175 | 60 | 20 | 1 | 25 |
| 97 | 103 | 163 | 63 | 17 | −3 | 21 |
| 98 | 10 | 10 | 100 | 21 | 27 | 23 |
| 99 | 9 | 9 | 100 | 22 | −3 | 19 |
| 100 | 9 | 9 | 100 | 19 | 109 | 15 |
| 101 | 8 | 8 | 100 | 23 | 115 | 24 |
| 102 | — | — | — | 47 | 112 | — |
| 103 | — | — | — | 42 | 117 | — |
| 104 | 23 | 24 | 96 | 23 | 30 | 23 |
| 105 | 21 | 23 | 91 | 25 | 0 | 28 |
| 106 | 120 | 465 | 26 | 50 | — | 21 |
| 107 | 114 | 450 | 25 | 55 | — | 22 |
| 108 | 53 | 90 | 59 | 42 | −1 | 61 |
| 109 | 54 | 92 | 59 | 42 | 2 | 59 |
| 110 | 56 | 96 | 58 | 41 | 3 | 57 |
| 111 | 55 | 94 | 59 | 40 | −2 | 52 |
| 112 | 55 | 93 | 59 | 37 | −4 | 53 |
| 113 | 52 | 97 | 54 | 43 | 0 | 54 |
| 114 | 54 | 89 | 61 | 44 | −1 | 52 |
| 115 | 53 | 88 | 60 | 43 | 4 | 52 |
| 116 | 54 | 91 | 59 | 41 | −3 | 53 |
| 117 | 52 | 95 | 55 | 38 | −3 | 54 |
| 118 | 51 | 92 | 55 | 39 | 4 | 56 |
| 119 | 52 | 94 | 55 | 37 | 1 | 55 |
| 120 | 52 | 95 | 55 | 38 | −1 | 53 |
| 121 | 53 | 91 | 58 | 38 | 3 | 54 |
| 122 | 54 | 93 | 58 | 37 | −2 | 52 |
| 123 | 53 | 94 | 56 | 40 | 2 | 51 |
| 124 | 52 | 92 | 57 | 39 | 0 | 51 |
| 125 | 54 | 91 | 59 | 38 | 1 | 52 |
| 126 | 51 | 89 | 57 | 39 | 5 | 53 |
| 127 | 53 | 89 | 60 | 39 | 0 | 51 |

TABLE 7

| Number | Number | | | | |
|---|---|---|---|---|---|
| of | of | Number | Heating step | Heating step | Z = |
| sample | brazing | of core | Heating timing | Heating | Σ (√(D · t)) |
| material | material | material | (Thickness (mm)) | condition | (m) |
| 128 | F1 | C1 | Intermediate annealing (0.6 t) | 400° C. × 10 m | 6.41E−05 |
| 129 | F1 | C1 | Intermediate annealing (0.6 t) | 400° C. × 1 h | 3.84E−04 |
| 130 | F1 | C1 | Intermediate annealing (0.6 t) | 400° C. × 3 h | 9.95E−04 |
| 131 | F1 | C1 | Intermediate annealing (0.6 t) | 400° C. × 7 h | 2.31E−03 |
| 132 | F1 | C1 | Intermediate annealing (0.6 t) | 400° C. × 20 h | 6.58E−03 |
| 133 | F1 | C5 | Intermediate annealing (0.6 t) | 400° C. × 10 m | 6.41E−05 |
| 134 | F1 | C5 | Intermediate annealing (0.6 t) | 400° C. × 1 h | 3.84E−04 |
| 135 | F1 | C5 | Intermediate annealing (0.6 t) | 400° C. × 3 h | 9.95E−04 |
| 136 | F1 | C5 | Intermediate annealing (0.6 t) | 400° C. × 7 h | 2.31E−03 |
| 137 | F1 | C5 | Intermediate annealing (0.6 t) | 400° C. × 20 h | 6.58E−03 |
| 138 | F1 | C1 | Finish annealing (0.4 t) | 400° C. × 10 m | 6.41E−05 |
| 139 | F1 | C1 | Finish annealing (0.4 t) | 400° C. × 1 h | 3.84E−04 |
| 140 | F1 | C1 | Finish annealing (0.4 t) | 400° C. × 3 h | 9.95E−04 |
| 141 | F1 | C1 | Finish annealing (0.4 t) | 400° C. × 7 h | 2.31E−03 |
| 142 | F1 | C1 | Finish annealing (0.4 t) | 400° C. × 20 h | 6.58E−03 |
| 143 | F1 | C5 | Finish annealing (0.4 t) | 400° C. × 10 m | 6.41E−05 |
| 144 | F1 | C5 | Finish annealing (0.4 t) | 400° C. × 1 h | 3.38E−04 |
| 145 | F1 | C5 | Finish annealing (0.4 t) | 400° C. × 3 h | 9.95E−04 |
| 146 | F1 | C5 | Finish annealing (0.4 t) | 400° C. × 7 h | 2.31E−03 |
| 147 | F1 | C5 | Finish annealing (0.4 t) | 400° C. × 20 h | 6.58E−03 |

| | Average | | Average length | | Corrosion | Corrosion |
|---|---|---|---|---|---|---|
| | length of α | | of α phase in | | resistance | resistance |
| | phase in | Residual | residual | | Core | Particle |
| Number | residual | brazing | brazing | Brazing | material | falling-off |
| of | brazing | material | material/ | Gap filling | corrosion | generation |
| sample | material | thickness | thickness | length | depth | portion |
| material | (μm) | (μm) | (%) | (mm) | (μm) | (%) |
| 128 | 53 | 92 | 58 | 42 | −2 | 57 |
| 129 | 56 | 91 | 62 | 43 | −6 | 53 |
| 130 | 55 | 93 | 59 | 44 | 1 | 58 |
| 131 | 57 | 91 | 63 | 42 | 2 | 55 |
| 132 | 59 | 89 | 66 | 44 | −5 | 56 |
| 133 | 51 | 89 | 57 | 43 | −1 | 53 |
| 134 | 53 | 93 | 57 | 44 | −5 | 54 |
| 135 | 56 | 91 | 62 | 42 | 2 | 54 |
| 136 | 55 | 91 | 60 | 43 | −1 | 52 |
| 137 | 57 | 92 | 62 | 41 | −2 | 52 |
| 138 | 54 | 95 | 57 | 42 | 4 | 54 |
| 139 | 57 | 89 | 64 | 41 | 3 | 52 |
| 140 | 55 | 91 | 60 | 41 | 2 | 53 |
| 141 | 58 | 92 | 63 | 40 | 1 | 54 |
| 142 | 58 | 95 | 61 | 39 | 5 | 52 |
| 143 | 52 | 91 | 57 | 43 | 3 | 58 |
| 144 | 54 | 90 | 60 | 40 | 2 | 57 |
| 145 | 55 | 93 | 59 | 42 | 1 | 58 |
| 146 | 56 | 91 | 62 | 41 | −2 | 54 |
| 147 | 56 | 89 | 63 | 41 | 6 | 56 |

From the results of Tables 3 to 7, the following can be seen. The sample materials Nos. 1 to 83 are based on the constitutions of the present invention. In all cases, the average length of the α phase remaining in the brazing material on the core material after brazing is not less than 70 μm, or not less than 80% of the residual brazing material thickness. All sample materials had excellent performance in terms of brazeability (gap filling length) and corrosion resistance (core material corrosion depth, ratio of particle falling-off generation portion).

On the other hand, in each of the sample materials Nos. 84 to 107, the composition of the brazing material deviates from that of the present invention. In many samples, the average length of the α phase remaining in the brazing material on the core material after brazing is less than 70 μm, or less than 80% of the residual brazing material thickness. All sample materials were inferior in one or both of brazeability (gap filling length) and corrosion resistance (core material corrosion depth, ratio of particle falling-off generation portion). In each of the sample materials Nos. 106 and 107, the brazing material is thick, and numerical value of X×Y is excessive. Since the absolute amount of the flowable brazing material increased, the change in thickness of the brazing sheet before and after brazing treatment increased, the average length of the α phase in the residual brazing material decreased, and the numerical values of the core material corrosion depth significantly varied, so that the measurement was difficult.

In each of the sample materials Nos. 88, 89, 102 and 103, the liquid phase fraction of the brazing material was 100%, the brazing material was apt to flow, the α phase was hardly generated in the residual brazing material, and it was difficult to measure the average length of the α phase. It was also difficult to measure the particle falling-off generation portion.

In each of the sample materials Nos. 108 to 147, the conditions of heat treatment deviate from those of the present invention. In all sample materials, since the heat treatment temperature was low, the average length of the α phase remaining in the brazing material on the core material after brazing was less than 70 μm, and less than 80% of the residual brazing material thickness. For this reason, the ratio of the particle falling-off generation portion was large, and the corrosion resistance was inferior.

This application claims priority to Japanese Patent Application No. 2015-150043 filed on Jul. 29, 2015, the disclosure of the application is incorporated herein by reference.

### DESCRIPTION OF REFERENCE NUMERALS

1, 10: Brazing sheet

2: Core material

3, 30: Brazing material

4: α phase

5: Eutectic phase

1. An aluminum alloy brazing sheet, comprising core material and a brazing material on at least one face of the core material,
wherein
the core material comprises an Al—Mn-based alloy or an Al—Mn—Cu-based alloy,
the brazing material comprises an Al—Si—Zn-based alloy comprising Si: 2 to 8% by mass and Zn: 1 to 9% by mass,
a liquid phase fraction X (%) at a brazing temperature of the brazing material and a brazing material thickness Y (μm) satisfy formulae (1) to (3) below:
30≤X≤80; (1)
Y≥25; and (2)
1000≤X×Y≤24000, and (3)
an average length of an α phase remaining in the brazing material on the core material after brazing satisfies at least one of not less than 80% of a thickness of a residual brazing material and not less than 70 μm.

2. The aluminum alloy brazing sheet according to claim 1, wherein the core material comprises an Al—Mn-based alloy or an Al—Mn—Cu-based alloy and comprises Mn: greater than 0% to 2.0% by mass and at least one of Cu: greater than 0% to less than 2.5% by mass and Si: greater than 0% to 1.7% by mass.

3. The aluminum alloy brazing sheet according to claim 2, wherein the core material comprises an Al—Mn-based alloy or an Al—Mn—Cu-based alloy and comprises Si: greater than 0% to 0.5% by mass.

4. A method for producing an aluminum alloy brazing sheet comprising a core material and a brazing material on at least one face of the core material,
wherein
a liquid phase fraction X (%) at a brazing temperature of the brazing material and a brazing material thickness Y (μm) satisfy formulae (1) to (3) below:
30≤X≤80; (1)
Y≥25; and (2)
1000≤X×Y≤24000, and (3)
the method comprising:
forming a core material by forming a material for the core material with an Al—Mn-based alloy or an Al—Mn—Cu-based alloy;
forming a brazing material by forming a material for the brazing material with an Al—Si—Zn-based alloy comprising Si: 2 to 8% by mass and Zn: 1 to 9% by mass;
performing a rolling by disposing the material for the brazing material on at least one face of the material for the core material and superposing the material for the core material and the material for the brazing material to pressure-bond these materials by hot-rolling and cold-rolling; and
heating by performing heat treatment in at least one stage of a middle stage of the cold rolling and after the cold rolling, at a temperature of not lower than 410° C., and not higher than 570° C. or at a solidus temperature of the brazing material or lower, for not less than 10 minutes and not more than 20 hours.

5. The method according to claim 4, wherein the core material comprises an Al—Mn-based alloy or an Al—Mn—Cu-based alloy and contains comprises Mn: greater than 0% to 2.0% by mass and at least one of Cu: greater than 0% to less than 2.5% by mass and Si: greater than 0% to 1.7% by mass.

6. The method according to claim 4, wherein the heat treatment is performed such that Z=Σ(√(D×t)) as an integrated value of a square root of a product of a diffusion coefficient D(m²/sec) and a heating time t(sec) satisfies a relational expression of 1E−4≤Z≤1E−2,
wherein the diffusion coefficient D is a function of a temperature T (° C.) of the aluminum alloy brazing sheet and is obtained from a formula below:
D=3.5/100000×EXP[−124×1000/{8.31×(T+273.15)}].

7. The method according to claim 5, wherein the heat treatment is performed such that Z=Σ(D×t)) as an integrated value of a square root of a product of a diffusion coefficient D(m²/sec) and a heating time t(sec) satisfies a relational expression of 1E−4≤Z≤1E−2,
wherein the diffusion coefficient D is a function of a temperature T (° C.) of the aluminum alloy brazing sheet and is obtained from a formula below:
D=3.5/100000×EXP[−124×1000/{8.31×(T+273.15)}].

8. A heat exchanger produced by forming the aluminum alloy brazing sheet according to claim 1, assembling and performing a brazing treatment.

9. A heat exchanger produced by forming an aluminum alloy brazing sheet obtained by the method for producing an aluminum alloy brazing sheet according to claim 4, assembling and performing a brazing treatment.

10. A heat exchanger produced by forming the aluminum alloy brazing sheet according to claim 2, assembling and performing a brazing treatment.

11. A heat exchanger produced by forming the aluminum alloy brazing sheet according to claim 3, assembling and performing a brazing treatment.

12. A heat exchanger produced by forming an aluminum alloy brazing sheet obtained by the method for producing an aluminum alloy brazing sheet according to claim 5, assembling and performing a brazing treatment.

13. A heat exchanger produced by forming an aluminum alloy brazing sheet obtained by the method for producing an aluminum alloy brazing sheet according to claim 6, assembling and performing a brazing treatment.

14. A heat exchanger produced by forming an aluminum alloy brazing sheet obtained by the method for producing an aluminum alloy brazing sheet according to claim 7, assembling and performing a brazing treatment.
